(19) United States
(12) Patent Application Publication
(10) Pub. No.: US 2026/0312484 A1
(43) Pub. Date: Oct. 8, 2026

(54) POWER CONVERTER WITH SWITCHED CAPACITOR VOLTAGE DIVIDER AND MULTIPHASE DC-DC VOLTAGE REGULATOR

(71) Applicant: The Trustees of Princeton University, Princeton, NJ (US)

(72) Inventors: Minjie CHEN, Princeton, NJ (US); Youssef ELASSER, Trenton, NJ (US); Jaeil BAEK, Chandler, AZ (US); Tanuj SEN, Princeton, NJ (US)

(73) Assignee: The Trustees of Princeton University, Princeton, NJ (US)

(21) Appl. No.: 18/880,750

(22) PCT Filed: Jul. 5, 2023
(86) PCT No.: PCT/US2023/026903

§ 371 Date: Jan. 2, 2025

Related U.S. Application Data
(60) Provisional application No. 63/358,265, filed on Jul. 5, 2022.

(51) Int. Cl. H02M 1/14; H01F 27/28; H02M 3/00; H02M 3/158

(52) U.S. Cl. CPC H02M 1/14; H01F 27/28; H02M 3/003; H02M 3/1586

(57) ABSTRACT

Disclosed is a multiphase coupled inductor structure fabricated without using magnetic materials. The 3D structure of the multiphase inductor creates an enclosed magnetic flux path and ensures close and symmetric coupling of multiple windings. Both theoretical analysis and experimental verification are disclosed.

### CROSS-REFERENCE TO RELATED APPLICATIONS

The present application claims priority to U.S. Provisional Patent Application 63/358,265, filed Jul. 5, 2022, which is incorporated by reference herein in its entirety.

### TECHNICAL FIELD

The present disclosure is generally drawn to the field of inductors, and foldable 3D polyhedral air-coupled inductors in particular.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Switch-mode power converters provides an output voltage that is different from the input voltage source. Certain known switch-mode power converters have parallel power cells with inputs coupled to a common voltage source and outputs coupled to a load, such as a microprocessor or a LED light. Multiple power-units can sometimes reduce cost by lowering the power and size rating of components. A further benefit is that multiple power units provide smaller per-power-unit peak current levels, combined with smaller passive components.

Parallel converter cells are usually switched in interleaving. Typically, the energizing and de-energizing of the inductance in each power unit occurs out of phase with switches coupled to the input, inductor, and ground. Additional performance benefits are provided when the switches of one power unit, coupling the inductors to the de input Voltage or to ground, are out of phase with respect to the switches in another power unit. Such a “multi-phase” interleaving parallel power unit technique results in ripple current cancellation at a capacitor, to which all the inductors are coupled at their respective output terminals. It also results in ripple current reduction at each of the individual cells, leading to significant benefits in terms of switch rating, conduction loss, and losses in magnetics.

### BRIEF SUMMARY

Various deficiencies in the prior art are addressed below by the disclosed devices, systems, and techniques.

In various aspects, a multiphase three-dimensional air-coupled inductor device may be provided. The three-dimensional multiphase air-coupled inductor device may include a plurality of air-coupled windings. A main magnetic path of each air-coupled winding may be operably coupled together in three-dimensional volume of space. Outer surfaces of the plurality of air-coupled windings may enclose a three-dimensional surface around the three-dimensional volume of space. Further, the multiphase air-coupled inductor device may include a uniform coupling coefficient for each air-coupled winding joined to another air-coupled winding.

The three-dimensional surface of the three-dimensional multiphase air-coupled inductor device may form a platonic structure. Further, the three-dimensional surface of the three-dimensional multiphase air-coupled inductor device may form a non-platonic structure. The outer surfaces of the three-dimensional multiphase air-coupled conductor may consist of planar surfaces. Further, the outer surfaces of the multiphase air-coupled inductor device may include a non-planar surface.

The three-dimensional multiphase air-coupled inductor device may contain a magnetic shield, included to guide magnetic flux. Further, the three-dimensional multiphase air-coupled inductor device may contain a ferrite sheet, included to guide magnetic flux.

Each air-coupled winding of the three-dimensional multiphase air-coupled inductor device may be wound in the same orientation. In some embodiments, at least one of the plurality of air-coupled windings may be wound in a different orientation from at least one other air-coupled winding of the plurality of air-coupled windings in the three-dimensional multiphase air-coupled inductor device.

In various aspects, a system may be provided. The system may include a three-dimensional multiphase air-coupled inductor device. The system may include at least one circuit operably coupled to the three-dimensional multiphase air-coupled inductor device.

The system may include contain a three-dimensional multiphase air coupled inductor. At least one circuit may be operably coupled to the three-dimensional multiphase air-coupled inductor device. The system may include at least one circuit that includes a conductive pattern on a printed board.

The system may contain a three-dimensional multiphase air coupled inductor where at least one circuit may be operably coupled to the three-dimensional multiphase air-coupled inductor device. The three-dimensional multiphase air-coupled inductor device may form an N-Phase power converter. Each phase may be controlled by an interleaved pulse-width modulated (PWM) signal.

In various aspects, a method for reducing phase current ripple may be provided. The method may include arranging at least four air-coupled windings in a three-dimensional structure in a manner such that a current would produce magnetic flux that points internal to the three-dimensional structure. The method may include introducing power to the at least four air-coupled windings in the three-dimensional structure. Introducing power may create a flux cancellation through destructive interference of magnetic fields produced by the at least four air-coupled windings in the three-dimensional structure. Introducing power may reduce a dampening voltage produced by the magnetic flux of the at least four air-coupled windings. The method may include coupling a power source to the at least four air-coupled windings in the three-dimensional structure.

In various aspects, a method for improving transient response may be provided. The method may include arranging at least four air-coupled windings in a three-dimensional structure in a manner such that a current would produce magnetic flux that points internal to the structure. The method may include introducing power to the at least four air-coupled windings in the three-dimensional structure. Introducing power may create a flux cancellation through destructive interference of magnetic fields produced by the at least four air-coupled windings in the three-dimensional structure. Introducing power may reduce a dampening voltage produced by the magnetic flux of the at least four air-coupled windings. This may cause a reduction in settling time of the at least four air-coupled windings. The method may include coupling a power source to the at least four air-coupled inductors in the three-dimensional structure.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows an illustration of multiphase PWM switching with multiphase coupled inductor.

FIG. 2 shows an embodiment of a tetrahedral four-phase air-coupled inductor.

FIG. 3 shows a schematic representation of the tetrahedron arrangement for the air-coupled inductor along with the current directions.

FIG. 4 shows a PCB implementation of the foldable three-dimensional polyhedron structure formed by taping individual PCB shapes together.

FIG. 5 shows a PCB implementation of the foldable three-dimensional polyhedron structure formed by taping individual PCB shapes together.

FIG. 6 shows a 3-D multi-surface structure with curved and non-planar surfaces and windings.

FIG. 7 shows a PCB based tetrahedron air-coupled inductor.

FIG. 8 shows an air-coupled inductor with a magnetic or ferrite shield.

FIG. 9 shows a schematic representation of an equilateral triangular inductor.

FIG. 10 shows a realization of the tetrahedron air-coupled inductor with the reluctance model.

FIG. 11 shows a realization of the tetrahedron air-coupled inductor with the approximate inductance dual model.

FIG. 12 shows a four-phase boost converter, operated with phase interleaving, with a four-phase tetrahedron air-coupled inductor.

FIG. 13 shows the measured self-inductance of the air-coupled inductor.

FIG. 14 shows the measured self-impedance of the air-coupled inductor.

FIG. 15 shows the simulation results for the four-phase interleaved boost converter at 1 MHz showing the inductor currents when using the air-coupled inductor as the input inductors.

FIG. 16 shows the simulation results for the four-phase interleaved boost converter at 1 MHz showing the switch voltages when using the air-coupled inductor as the input inductors.

FIG. 17 shows the simulation results for the phase currents in the boost converter circuit at 1 MHz with the air-coupled inductor with interleaving.

FIG. 18 shows the simulation results for the phase currents in the boost converter circuit at 1 MHz with the air-coupled inductor without interleaving.

FIG. 19 shows the simulation results for the output voltage transient of the interleaved four-phase boost converter for a step change in the duty ratio.

FIG. 20A shows an embodiment of a hardware embodiment of a single phase boost converter with a PCB based triangular discrete air-core inductor.

FIG. 20B shows an embodiment of a hardware embodiment of a single phase boost converter with a PCB based three-dimensional air-coupled inductor.

FIG. 21A shows experimental results for the operation of the four-phase interleaved boost converter operating in the Discontinuous Conduction Mode at 1 MHz switching frequency and a duty ratio of 0.8 the interleaved switch voltages showing zero voltage switching.

FIG. 21B shows experimental results for the operation of the four-phase interleaved boost converter operating in the Discontinuous Conduction Mode at 1 MHz switching frequency and a duty ratio of 0.8 and the current ripple along with an additional ripple at 4 MHz due to the air-coupled inductor.

FIG. 22A shows experimental results for the operation of the four-phase interleaved boost converter operating in the Discontinuous Conduction Mode (DCM) at 10 MHz switching frequency and a duty ratio of 0.4 the interleaved switch voltages showing zero voltage switching (ZVS).

FIG. 22B shows experimental results for the operation of the four-phase interleaved boost converter operating in the Discontinuous Conduction Mode (DCM) at 10 MHz switching frequency and a duty ratio of 0.4 the input current flowing through each phase of the air-coupled inductor.

FIG. 23 shows a comparison of the input current ripple for one of the phases of the interleaved boost converter in CCM with and without the air-coupled inductor.

FIG. 24 shows a comparison of the input current ripple for one of the phases of the boost converter in CCM with and without interleaving, showing the effect of the air-coupled inductor in significantly reducing the input current ripple.

FIG. 25 shows experimental results comparing the output voltage transient response of the converter in CCM with and without the air-coupled inductor for a 5% step change in the duty ratio from 67% to 72%.

FIG. 26 shows a comparison of the converter efficiency with the designed air-coupled inductor (blue) and the efficiency for the uncoupled converter (red) at 5 MHz switching frequency.

FIG. 27 shows a flowchart of a method to reduce the current ripple.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The present disclosure relates to a three-dimensional air-coupled inductor and a method to minimize the flaws present in the prior art. More specifically, the present disclosure aims to reduce the current ripple, improve the transient speed of air-coupled inductors, and generally increase the efficiencies of boost converters. These three-dimensional air-coupled inductors may have various uses in applications such as voltage regulators, microprocessors, or power converters in telecommunications.

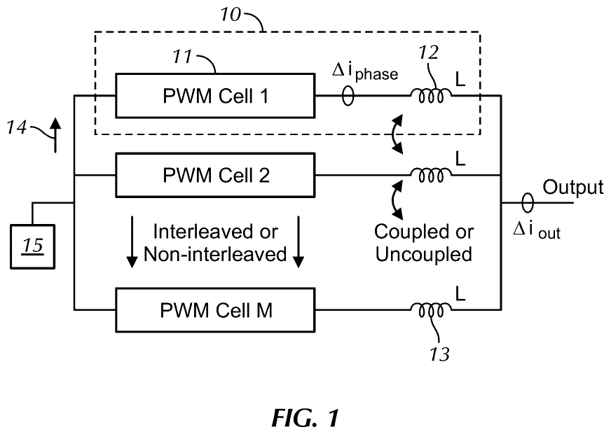

FIG. 1 shows a block diagram of an example multiphase pulse width modulator (PWM) system in series with an inductor. A power source 15 inputs energy into the system and causes a current to flow 14 through the system. One or more PWM-Inductor subunits 10 regulates the average power flowing through the circuit, where the current flow to the PWM 11, then through an inductor 12, such as an air core inductor.

As shown in FIG. 1, the system may include a plurality of PWM-inductor subunits, in parallel. Interleaving may help to improve the performance of paralleled power converters through ripple reduction. Coupling the inductors of multiple interleaved cells can extend the ripple reduction, achieved in the input current and the output voltage, even to the current ripples of the individual PWM cells 11. The strong coupling of discrete inductors, such as depicted in FIG. 1, has been shown to greatly reduce the inductor size, losses, and improve the control bandwidth of a variety of multiphase interleaved power converters.

Conventionally, coupled inductors 12, 13 applied to multiphase interleaved power converters usually include a magnetic core to enhance the magnetic coupling between phases. But, in the high frequency regime (e.g., between 3 MHz to 30 MHz), high performance magnetic materials tend to have low permeability and thus cannot offer high coupling coefficients between the coupled inductors 12, 13. The operation of discrete air-coupled inductors in the high-frequency regime suffers from current ripple and slow transient response times. The disclosed techniques provide various benefits including, inter alia, resolving the issues seen in conventional approaches.

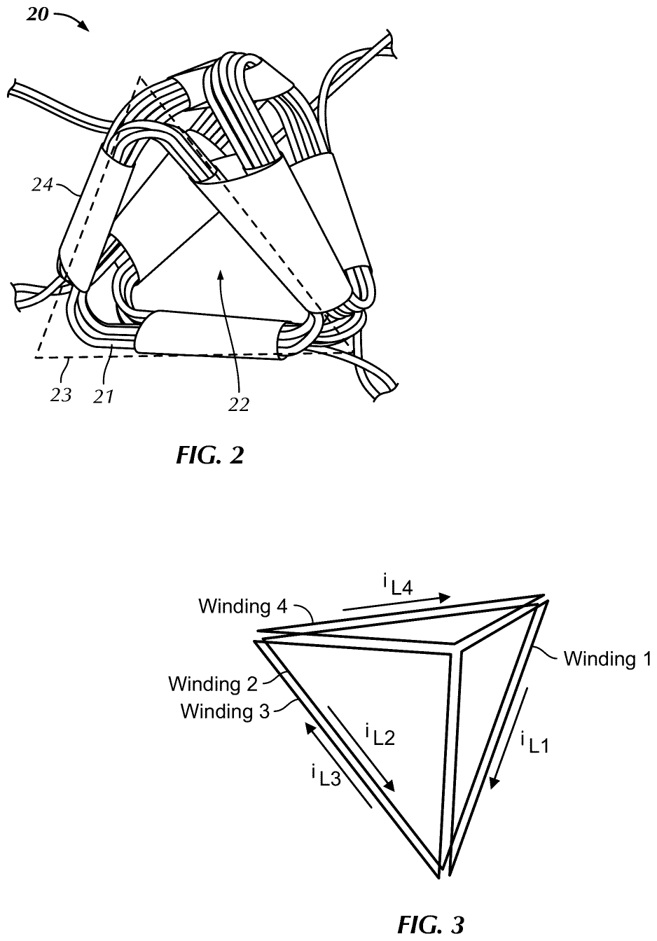

Referring now to FIG. 2, an example embodiment of a three-dimensional air-coupled inductor 20 is composed of a plurality of air-coupled windings 21. The three-dimensional air-coupled inductor in FIG. 2 is composed of four separate windings 21, each winding having an empty volume of space in an intermediate portion of the winding (e.g., an air gap). Each winding may, individually, have a hollow, generally geometric shape. For example, each winding may, independently, have a hollow, generally cylindrical shape, a hollow, generally triangular prism shape (as seen in FIG. 2), a hollow rectangular shape, etc. In some embodiments, each winding has the same geometric shape. In some embodiments, at least one winding has a different geometric shape.

The windings 21 may be composed of any appropriate conductive material. The windings may be composed of a metal, such as silver or copper.

The plurality of windings are configured such that a main magnetic path of each winding is operably coupled together in a three-dimensional volume of space.

The windings may be arranged such that an outer surface of each winding defines an imaginary plane 23, when arranged as part of the three-dimensional air-coupled inductor. The outer surface of the windings may enclose a three dimensional surface around the three-dimensional volume of space. The imaginary plane may form a face of a polyhedron.

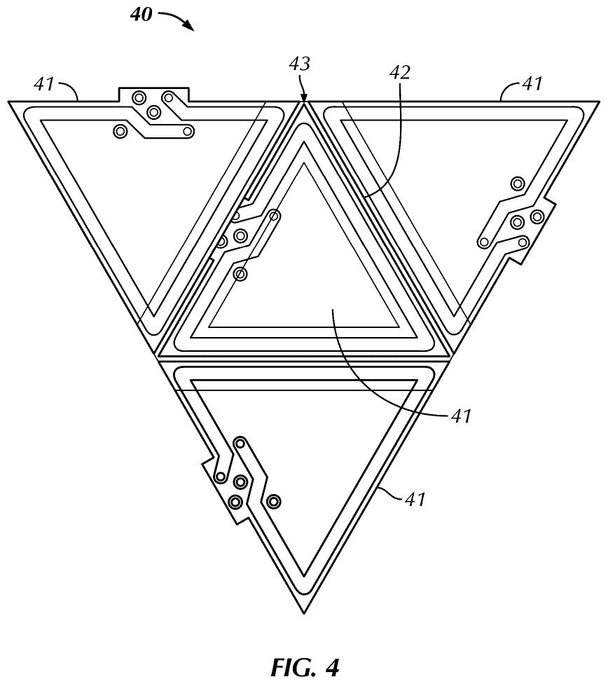

The configurations of the air-coupled windings 21 may take on several forms. In some embodiments, each of the air-coupled windings may be wound such that each air-coupled winding is wound in the same orientation as the other faces 23. In some embodiments, at least one of the air-coupled windings may be wound in a different orientation from at least one other air-coupled winding. By adjusting the orientations of the windings, the directions of the de currents can be changed. Referring briefly to FIG. 3, a configuration can be seen wherein the orientation of the windings permits de current to flow in the same direction.

Referring again to FIG. 2, each face 23 of the three-dimensional air-coupled inductor device 20 may be composed of the air-coupled windings 21.

Each winding may be wound N times. In some embodiments, 1≤N≤100. In some embodiments, 1≤N≤50. In some embodiments, 1≤N≤10. In some embodiments, 3≤N≤7. Like the incongruencies which may exist in the orientation of the windings 21, at least one of the air-coupled windings 21 may contain more or less windings than at least one other air-coupled winding 21. The number of turns and orientation of the windings 21 may be selected to support the functionality of a PWM converter. Preferably, the orientation of all windings 21 in the same direction and carrying the dc current in the same direction, the coupling is directed to reduce the ripple current flowing in all windings 21, which is beneficial for improved power converter performance.

The plurality of air coupled windings 21 may be operably coupled together to form a polyhedron structure in the three-dimensional Euclidean volume of space, as shown in FIG. 2. The coupling of these wires may be accomplished in any appropriate manner. For example, as in FIG. 2, may be done by, e.g., an adhesive material 24.

The result of the operably coupled air-coupled windings 21 is a three-dimensional air-coupled inductor with an air-core 22.

In some embodiments, a three-dimensional air-coupled inductor may include a structural substrate, such as a rigid polymer, or a printed circuit board (PCB). Referring to FIG. 4, an “unfolded” three-dimensional air-coupled inductor device can be seen. The device has four triangular “sides” 41 or faces, each of which operably coupled to at least one adjacent side along a connecting edge 42. In some embodiments, each “side” or face is a discrete part. In some embodiments, the entire structure is a single part, hingedly coupled together along an inner part of the connecting edges. Each winding (here, only a single winding 43 is shown) may be disposed along a connecting edge of a given “side” or face, one winding per “side” or face. By disposing the individual PCB inductors 43 along the connecting edges 42 of the printed circuit board 40, the edges will then form a three-dimensional origami-like structure when the device is “folded”. For multi-phase use, this arrangement results in the windings of two adjacent phases, forming at a connecting edge 42 of the polyhedron structure, to be coupled through the air.

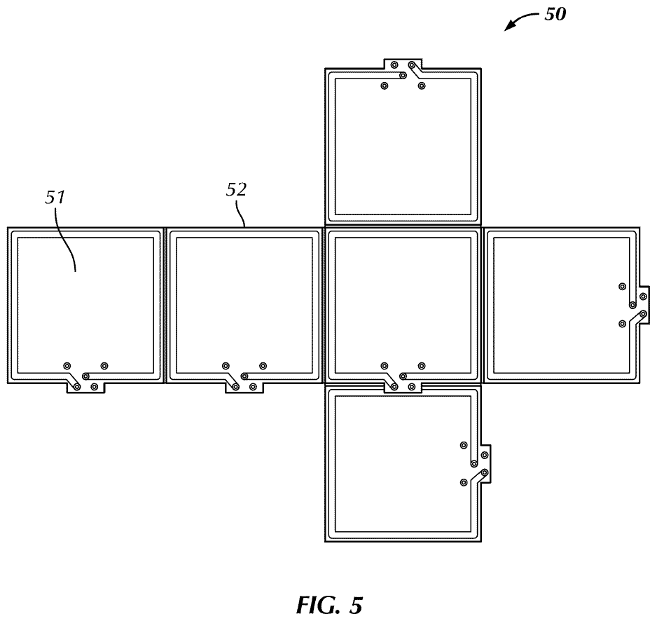

The three-dimensional polyhedron structure may form any three-dimensional shape. By way of example, while FIGS. 2 and 3 depict the three-dimensional air coupled inductor in the form of a tetrahedron. In some embodiments, referring to FIG. 5, the three-dimensional air-coupled inductor may also take the form of a cube 50. In this embodiment, the cube contains six operably coupled faces 51. A winding may be operably coupled to the inner edge 52 of each face. Thus, when the structure is folded, the edges 52 of each face 51 come together to form a three-dimensional air-coupled inductor in the shape of a cube.

The three-dimensional polyhedron may also take the form of several other structures, including but not limited to, a dodecahedron, octahedron or icosahedron.

While the above listed three-dimensional structures all form platonic structures, the three-dimensional air-coupled inductor is not limited to these embodiments. Instead, the polyhedron may take the form of a non-platonic structure. Such non-platonic structures may include, e.g., a convex, regular polyhedron. For example, in some embodiments, the three-dimensional structure may take the form of a tridecagon which has thirteen sides but does not form a platonic structure.

The three-dimensional structures assumed by the inductor devices may take the form of a planar structure. The three-dimensional structures assumed by the inductor devices may take the form of a non-planar structure.

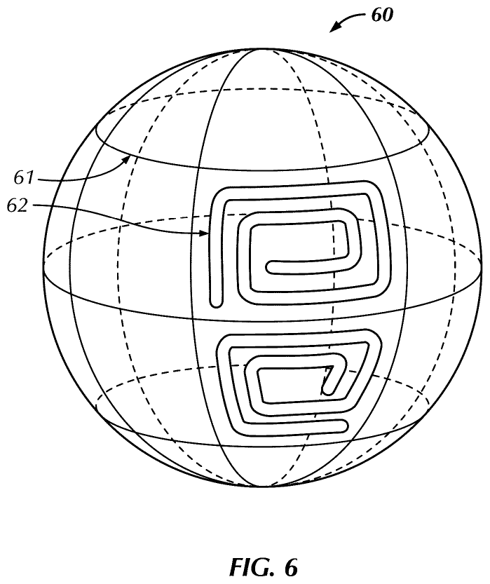

As an example, the embodiment depicted in FIG. 6 represents a spherical non-planar surface of a three-dimensional air-coupled inductor 60. In this embodiment, the air-coupled windings 62 may each form non-planar surfaces. The edge 61 of these surfaces, when operably coupled together will form the non-planar three-dimensional air-coupled inductor.

The three-dimensional air-coupled inductor device is not limited to any set volume and may be as large or small as needed. In some embodiments, the devices encompass a volume of less than 1 cm³. In some embodiments, the devices encompass a volume of less than 10 cm³. In some embodiments, the devices encompass a volume of less than 1 m³. In some embodiments, the devices encompass a volume of less than 10 m³.

Compared to discrete, uncoupled inductor implementations, a polyhedron air-coupled inductor offers smaller current ripple and faster transient speed. Further, the three-dimensional structure of the air-coupled inductors causes flux cancellation and leads to a more compact magnetic field spread in comparison to discrete uncoupled inductors. As a result, the tetrahedron coupling significantly reduces the volume occupied by the magnetic flux. With tetrahedron coupling, air-core inductors can be placed more closely together to improve power density.

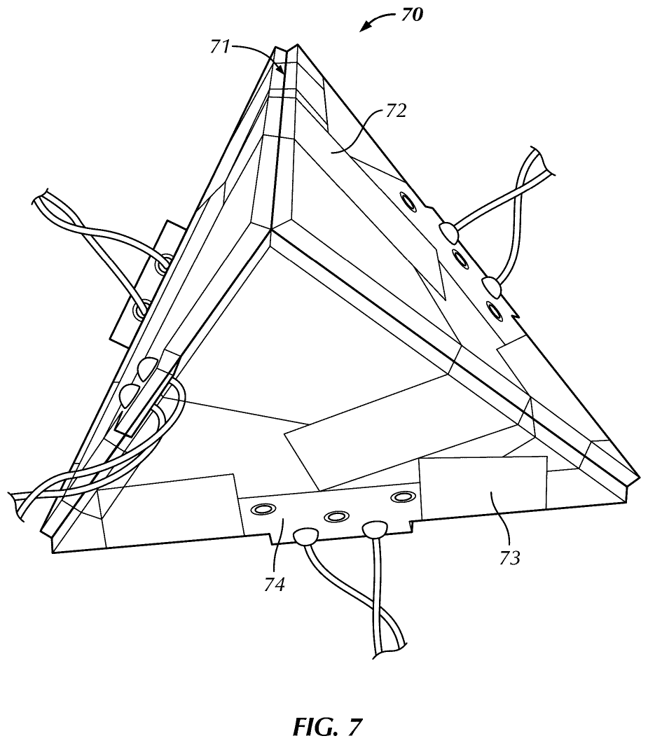

Conventionally, non-three-dimensional air-core inductors require a form of shielding to limit magnetic field emission. As current passes through the inductors, a resultant magnetic field is emitted which induces a current through the surrounding inductors, this phenomenon is known as self-inductance. To limit the magnetic field emission by conventional discrete air-core inductors, all faces of the inductor must be shielded. However, referring to FIG. 7, for a polyhedron coupled inductor 70, only the outer faces 72 of the polyhedron inductor need to be shielded.

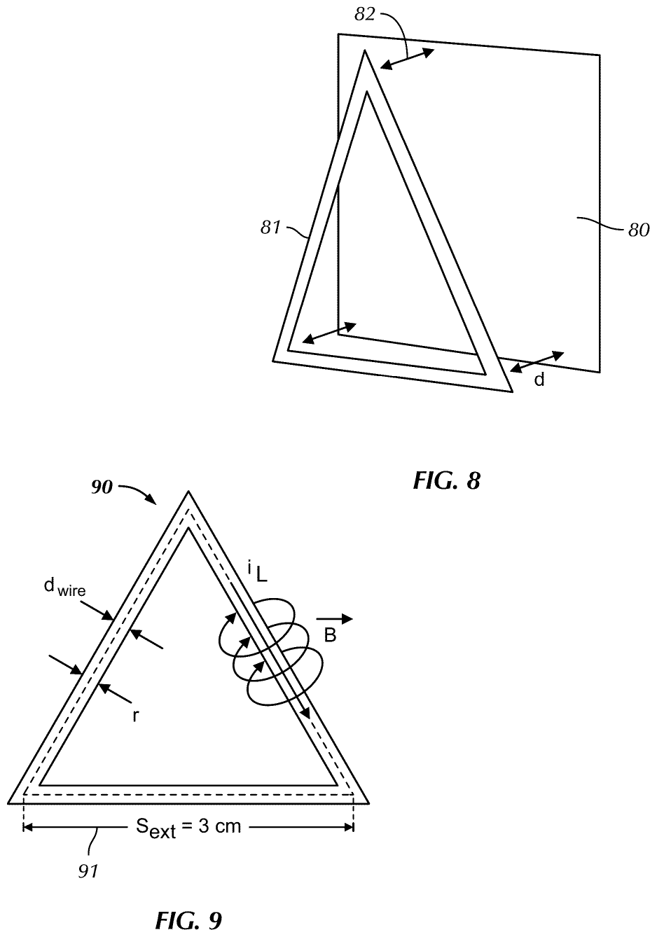

Referring to FIG. 8, the shield 80 may be constructed with a magnetic material. The shield may be constructed with a ferrite material. The shield may also be separated a distance (d) 82 from the outer face of the three-dimensional air-coupled inductor. Using a shield 80 for the three-dimensional air-coupled inductors 20 allows the magnetic flux to be guided by the either magnetic or ferrite sheet. By coupling a shield 80 to the polyhedron structure, the self-inductance of the air-coupled inductors is reduced by a lesser extent in comparison to the self-inductance of the shielded discrete inductors for a given clearance distance, d 82. The eddy current losses would also be lesser for the shielded coupled inductor. Hence, even with shielding the three-dimensional air-coupled inductor provides better performance in comparison to the discrete air-core inductors.

Referring again to FIG. 7, the three-dimensional multiphase air-coupled inductor device may also be operably coupled to at least one circuit 74. The at least one circuit may be, e.g., a printed conductive pattern on a substrate, such as a circuit board. The at least one circuit may be coupled to an external surface 73 of the inductor device.

FIG. 9 shows the structure of an air-core inductor 90 in the shape of an equilateral triangle with a side length 91 of 3 cm. Four such discrete inductors are arranged and operably coupled together to form a symmetric Platonic structure known as a tetrahedron. Each face of this tetrahedron represents one of the phases of a four-phase coupled inductor and each phase edge is adjacent to an edge of one of three other phases of the coupled inductor. The self-inductance of each discrete inductor with dimensions as labeled in FIG. 9 is given as:

$$1. {L}_{S} = 6 \times {N}^{2} \times 1 {0}^{- 7} {s}_{ext} [ ln \frac{{s}_{ext}}{r} - 1.40546 + \frac{{μ}_{r}}{4} ]$$

Here L_{S} is the self-inductance in Henry. N is the number of turns of the inductor, sₑₓₜ, is the length of the triangular edge in meters, r is the radius of the wire in meters, and μᵣ is the relative permeability of the wire.

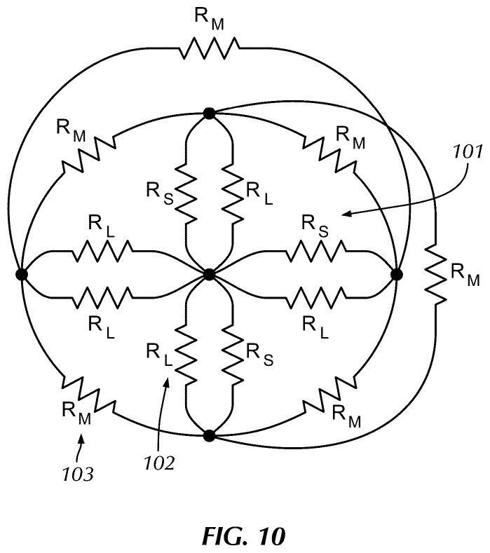

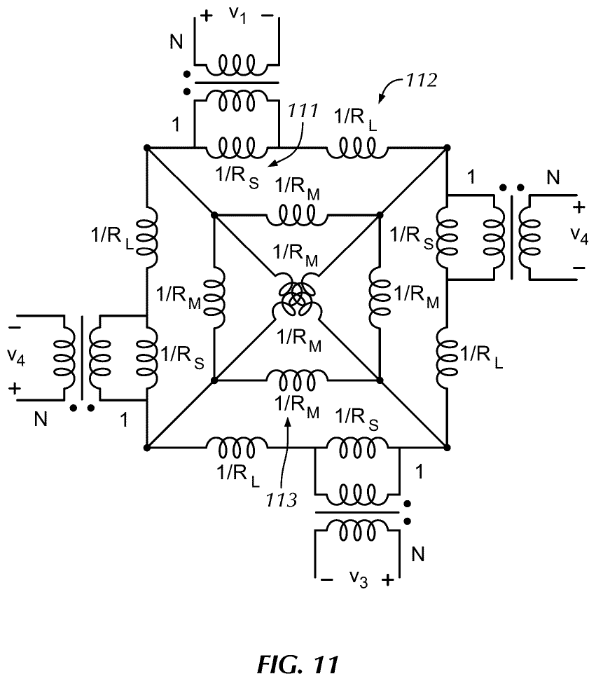

The benefits of multiphase coupling can be described as a function of the coupling coefficient, similar to cored inductors. The polarity of the four phase windings are selected such that the currents flowing in the windings result in the magneto-motive forces (MMF) all pointing inside or outside relative to each face of the coupled inductor, i.e., the currents are either all flowing clockwise or counter clockwise. FIG. 10 shows a model-based analysis of the tetrahedron air-coupled inductor. All MMFs point outwards from the central node, leading to a non-planar reluctance model as shown in FIG. 10. [symbol] 101 and [symbol] 102 represent the self and leakage reluctance associated with each winding, while [symbol] 103 represents the reluctance experienced by the flux linking between two windings. An inductance dual model as shown in FIG. 11 can then be derived, with all inductance values 111, 112, 113 inversely related to these reluctances. The non-planar reluctance model leads to a non-linear inductance dual model for the coupled inductor. This inductance dual model allows the coupled inductor to be simulated. Higher order polyhedron coupled inductors can be modeled in a similar way. The inductance matrix of such a coupled inductor is:

$$a . [ \begin{matrix}{v}_{1} \\ {v}_{2} \\ ⋮ \\ {v}_{m}\end{matrix} ] = [ \begin{matrix}{L}_{11} & {L}_{12} & ⋯ & {L}_{1 M} \\ {L}_{21} & {L}_{22} & ⋯ & {L}_{2 M} \\ ⋮ & ⋮ & ⋱ & ⋮ \\ {L}_{M 1} & {L}_{M 2} & ⋯ & {L}_{MM}\end{matrix} ] [ \begin{matrix}\frac{{di}_{1}}{dt} \\ \frac{{di}_{2}}{dt} \\ ⋮ \\ \frac{{di}_{M}}{dt}\end{matrix} ]$$

Here, vₙ represents the N^{th} phase voltage, Lₙₙ represents the self-inductance of the N^{th} phase, while L_{KN} is the mutual inductance between the K^{th} and N^{th} phase. The rate of change of the phase current is given by

$$\frac{{di}_{N}}{dt} .$$

Thus, the matrix representation shows how the voltages and currents of M phases are coupled together by a coupled inductor.

### Example 1

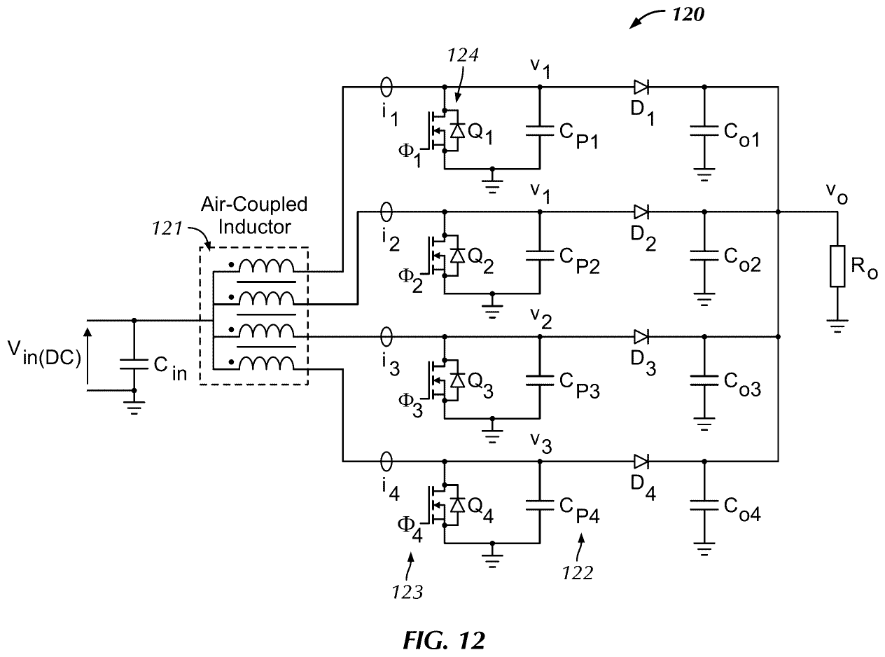

A four-phase boost converter with interleaved phases is shown in FIG. 12. The shown four-phase boost converter with interleaved phases includes a three-dimensional air-coupled inductor device (e.g., device 70 of FIG. 7). The converter 120, operated with phase interleaving, with a four-phase tetrahedron air-coupled inductor 121 was used to simulate the effects of a three-dimensional air-coupled inductor 121. The converter was designed to provide a maximum output voltage of 70V, operating at switching frequencies ranging from 1 MHz to 10 MHz. The switch labeled capacitances are represented separately in FIG. 12 and labelled as C_{Pn} 122, while Φₙ 123, represents the phase angle of the gate signals driving the n^{th} switch 124 of the interleaved dc-dc converter. The converter is operated with both the tetrahedron air-coupled inductor and the discrete triangular air-core inductors.

Using the design principles of the tetrahedron air-coupled inductor, an air-coupled inductor was created by framing a planar triangular air-core inductor on PCB and putting four such planar inductors together to form a tetrahedral PCB based air-coupled inductor. The design of this inductor is presented in FIG. 7. These triangular inductors were fabricated on a four-layer PCB, with each layer having one turn of the inductor. The four-layer PCB boards are coupled together at the connecting edges by an adhesive film. The trace width of these turns is 80 mils (approx. 2 mm) and the edge 71 length is 2000 mils (approx. 5 cm). The self-inductance and de resistance of this inductor are measured to be 1.306 μH and 99.85 mΩ, respectively. The measured mutual inductance between two phases is −0.364 μH. These inductance values were measured at a frequency of 10 MHz.

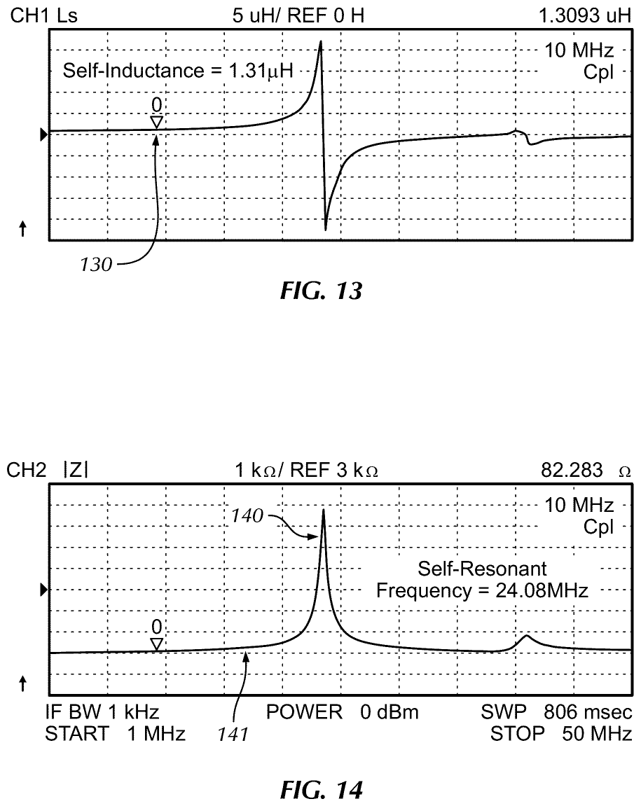

FIGS. 13 and 14 show the measured self-inductance 140 and impedance 130 curves for one of the phases of the air-coupled inductor. The self-resonant frequency 141 for one of the phases of the air-coupled inductor is 24.08 MHz. The inter-winding capacitance is non-negligible and limits the range of operation of the designed coupled inductor.

### Example 2

The four-phase interleaved boost converter 120 (see FIG. 12) with the air-coupled inductor as the input inductor was simulated to evaluate the impact of the air-coupled inductor on the input current ripple and the transient response of the converter. The power devices are modeled as ideal switches with a capacitance of 110 pF placed in parallel to each switch, to account for the output capacitance of the real power device used in the experiment. The air-coupled inductor was modelled using the self and mutual inductance values measured for the tetrahedron air-coupled inductor shown in FIG. 7. The phase currents flowing through the individual phases of the air-coupled inductor were observed to highlight the reduction in the input current ripple, and the output voltage of the converter was measured for a step change in the load.

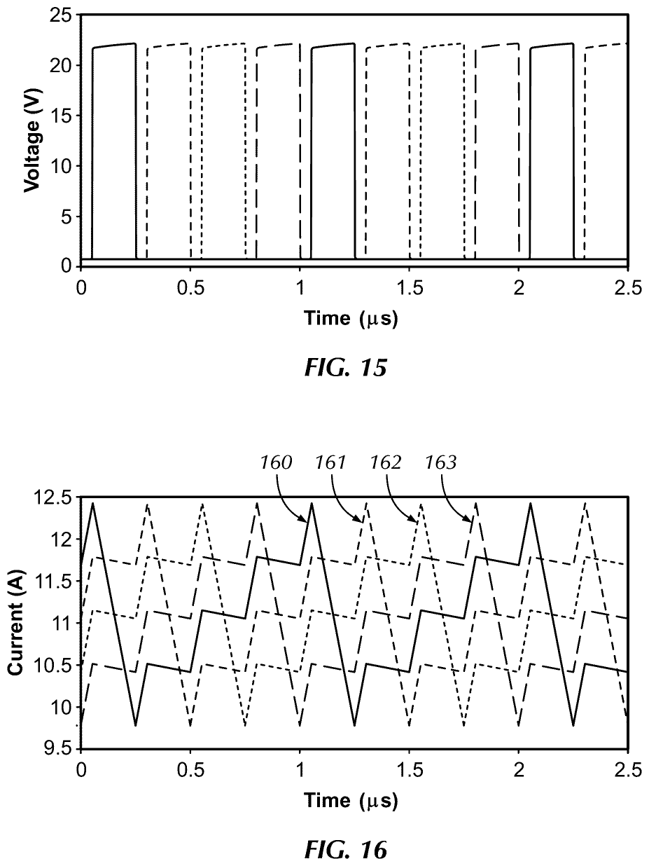

The operation of the four-phase interleaved boost converter 120 with the designed air-coupled inductor was simulated at a switching frequency of 1 MHz. The converter 120 was supplied with an input voltage of 5V, while the output of the converter was connected to a load of 2.5Ω, to ensure operation in the continuous conduction mode (CCM). The switches were operated with a duty ratio of 0.8, with symmetrically interleaved gate signals. The simulation results are shown in FIGS. 15 and 16 which depict the current ripples 160, 161, 162, 163 as a function of time. The four phase inductor currents show an additional current ripple four times the switching frequency (4 MHz) along with the main current ripple at 1 MHz, which highlights the impact of the air-coupled inductor on the converter operation.

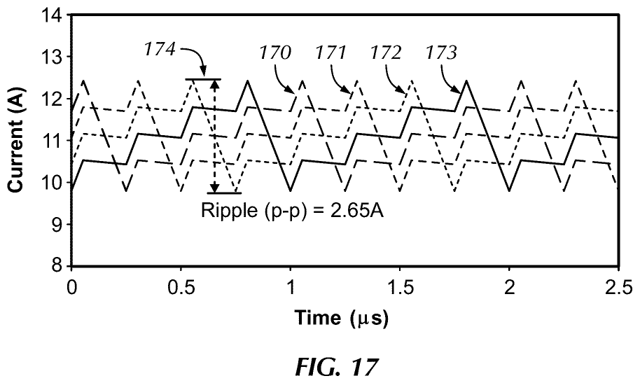

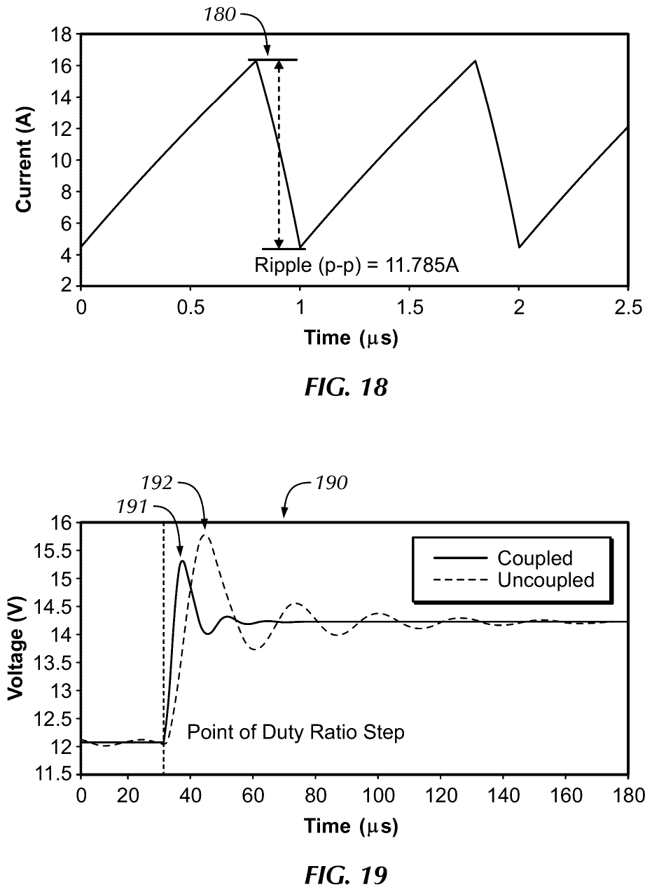

FIGS. 17 and 18 provide a comparison of the input current ripples 170, 171, 172, 173 observed with and without interleaving between phases. As shown in FIG. 17, when the switches are operated with interleaving, the switch voltages are also symmetrically interleaved with respect to each other and the coupling effect of the air-coupled inductor introduces an additional current ripple at four times the switching frequency, which helps to reduce the overall peak-to-peak 174 ripple in the phase currents. When the switch gate signals are not interleaved, the switch voltages of all four phases of the converter are in phase. Hence, the benefits of coupling disappear, yielding a drastic increase in the peak-to-peak 180 input current ripple, as can be seen in FIG. 18. This shows the advantage of the air-coupled inductor in reducing the peak-to-peak 174, 180 input current ripple, when the individual phases of the converter are interleaved and coupled.

The verification of the improvement in the transient response provided by the air-coupled inductor was completed through a separate simulation. This simulation compared the transient response of the four-phase interleaved boost converter 120 with and without the air-coupled inductor. The input voltage was set at 4V and the converter load was configured to be a constant current load of 1.5 A. The converter 120 was operated in CCM and the duty ratio was changed from 67% to 72%, with a transition time of 1 ns.

The results are provided in FIG. 19. It is assumed that the settling time is denoted as the time taken for the magnitude of the oscillations in the output voltage to drop down to 10% of the voltage step change due to the duty cycle step 193. With the coupled inductor, the output voltage 194 of the open loop converter settles in about 19 μs compared to about 67 μs for the uncoupled converter. The voltage overshoot is also reduced when the phases are coupled. The simulation results 190 for the output voltage 194 transient of the interleaved four-phase boost converter for a step change in the duty ratio are shown in FIG. 19. The transient response 191, 192 is for the open loop system operating in the continuous conduction mode.

### Example 3

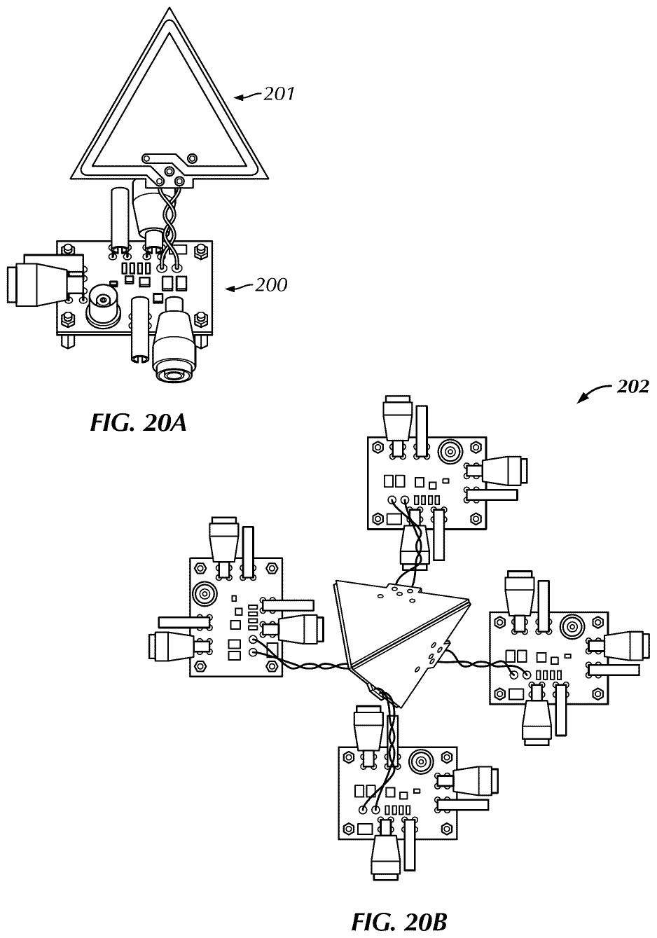

Experiments similarly verify the effectiveness of the disclosed multiphase three-dimensional air-coupled inductors. The experiment was designed to compare the effectiveness of the air-coupled inductors for reducing the amplitude of input current ripple as well as providing an improved transient response against the discrete inductors. Referring to FIGS. 20A and 20B, the experiment was constructed using the single-phase boost converter 200 with a PCB based triangular discrete air-core inductor 201 as the control. The control was tested against the four-phase boost converter with the PCB-based three-dimensional tetrahedron air-coupled inductor device 202 of FIG. 20B (e.g., four of FIG. 20A, where the inductors were arranged in a tetrahedron). The circuit operation was tested in Continuous Conduction Mode (CCM) as well as in Discontinuous Conduction Mode (DCM) in order to achieve Zero Voltage Switching (ZVS) or the switches. The converter was operated at various switching frequencies ranging between 1 MHz to 10 MHz to verify the functionality of the designed air-coupled inductors. The devices in FIGS. 20A and 20B was tested at a switching frequency of 1 MHz with the PCB-based air-coupled inductors as the input inductors, and the switches of the four boost converters operated with interleaving at a duty ratio of 0.8.

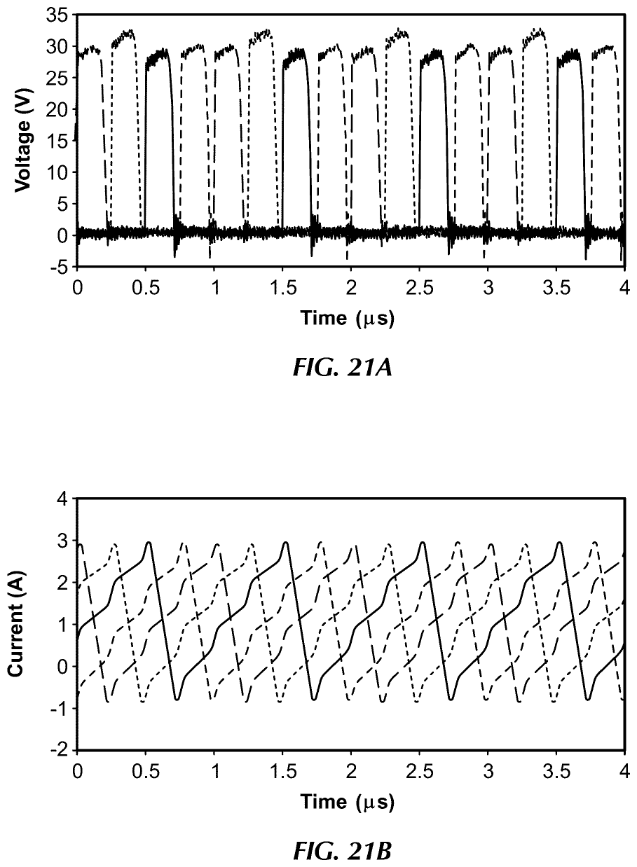

FIGS. 21A and 21B shows the switch voltages (21A) and the phase currents (21B) when the converter is operated in DCM to achieve ZVS. The input voltage was set at 6.75 V with a constant current load of 0.8 A. In FIG. 21B, the individual phase currents show an additional ripple at 4 MHz superimposed on the main current ripple at 1 MHz, which highlights the coupling between the phases provided by the PCB-based three-dimensional tetrahedron air-coupled inductor device 202.

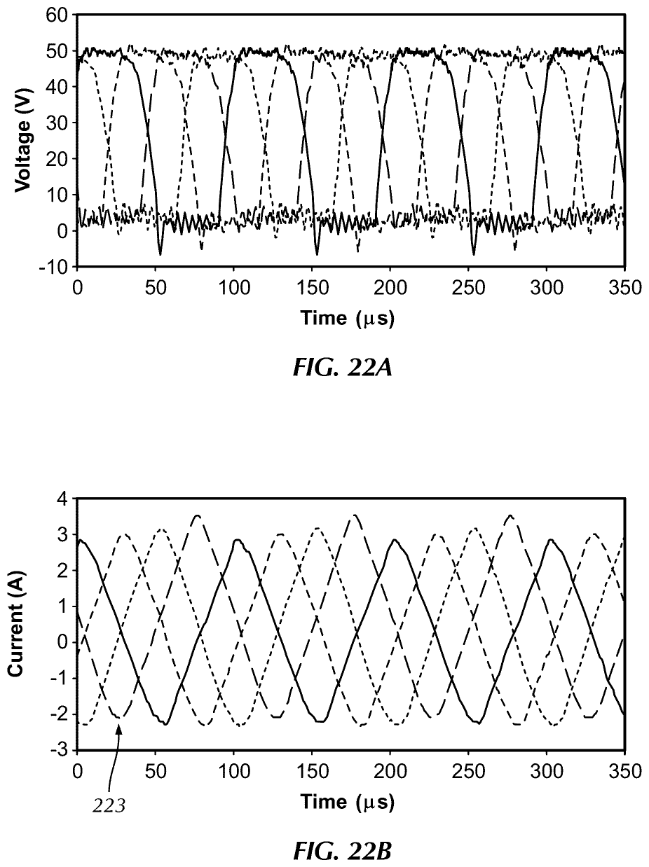

Similarly, FIGS. 22A and 22B shows the switch voltages (22A) and phase currents 222 (22B) for the four-phase interleaved boost converter when operated at a switching frequency of 10 MHz in DCM, again to achieve ZVS. The input voltage for this case was set at 26V. The load was a constant current load of 0.6 A. The switches are operated at a duty ratio of 0.4. The phase currents in FIG. 22B, however, do not show any clear current ripples at 40 MHz. Since the self-resonant frequency of the PCB based air-coupled inductor is 24.08 MHz, as well as due to the bandwidth limitations of the current probes used for measuring the phase currents, the amplitude of a measured current ripple 223 due to the coupled inductor at 40 MHz gets impacted.

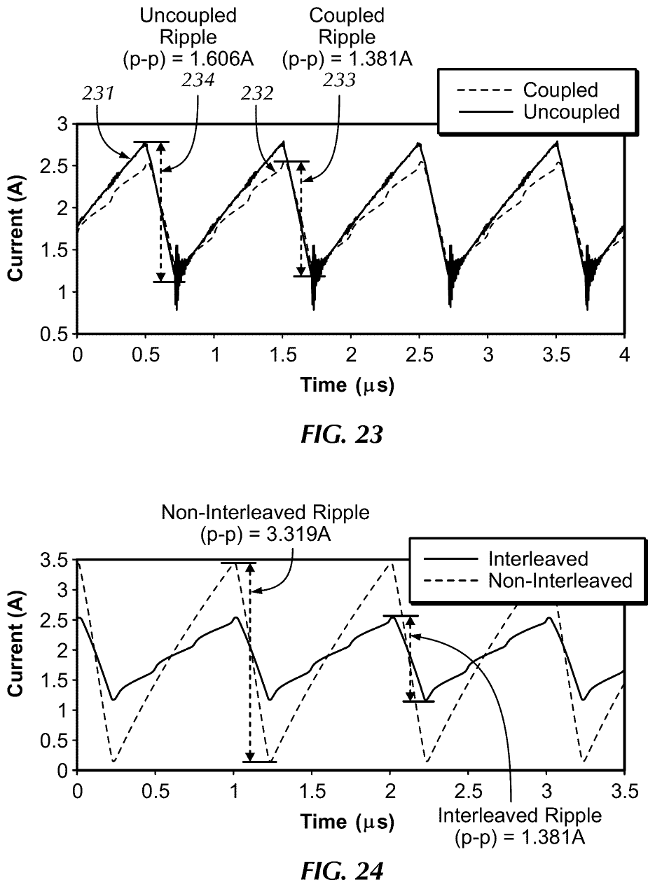

Referring now to FIG. 23, the experimental verification of ripple reduction is shown. For this verification, the change in the phase current ripple 231, 232 was measured for the device in FIG. 20B. The four-phase boost converter was operated in CCM with interleaved phases for these measurements. FIG. 23 shows the phase current ripples 231, 232 at a switching frequency of 1 MHz and a duty ratio of 0.8. The input voltage was set at 3V and the load was set at a constant current load of 1.2 A. Only one phase current is shown for the sake of clarity. The total phase current ripple 231, 232 when using the PCB based air-coupled inductor as the input inductor is 1.381 A, while the same when the phase inductors are not coupled turns out to be 1.606 A. It can be observed that the input current ripple 231 of the uncoupled inductor 201 of FIG. 20A is 0.225 A greater than the ripple current of the multiphase inductor (e.g., PCB-based three-dimensional tetrahedron air-coupled inductor device 202) of FIG. 20A. This corresponds to a 14% decrease in the ripple current between a discrete inductor and an embodiment of the disclosed invention.

The phase current ripples were also tested for the four-phase boost converter at 1 MHz and a duty ratio of 0.8, with and without interleaving, to examine how the air-coupled inductor works jointly with phase interleaving to greatly reduce the current ripple. The converter was operated in CCM for this case as well. The input voltage and the load were the same as above. The tested phase current ripples with and without interleaving are shown in FIG. 24. It can be observed that when the switches are operated without interleaving, the total current ripple is almost 2.5 times greater than the phase current with interleaving. These experimental results highlight the utility of air-coupled inductors in reducing the total phase current ripple. These experimental results also verify the functionality of the designed air-coupled inductors.

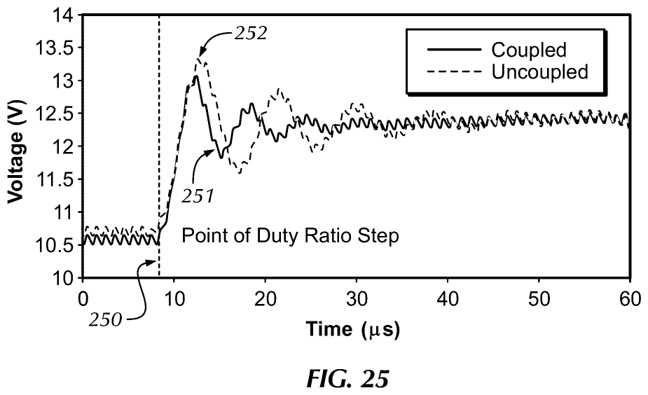

Referring now to FIG. 25, an experimental comparison of the transient response between the disclosed multiphase three-dimensional air-coupled inductor and the discrete inductors is shown. For this, the four-phase interleaved boost converter (e.g., PCB-based three-dimensional tetrahedron air coupled inductor device 202) (see FIG. 20B) with and without the air-coupled inductor, is subject to a step change in the duty ratio, from 67%-72%, with a transition time of 1 ns. The input voltage of the converter was set at 4 V and the electronic load was configured in the constant current mode to carry a constant current of 1.5 A. The current was operated in the CCM. The actual voltage output behavior due to a duty ratio step shows similar characteristics as seen in the simulation results. With the coupled inductor 251 the output voltage transient is faster. The converter settles to its new output voltage value after around 14 μs. From the instant of the duty ratio step change 250. However, when discrete inductors 252 are used, the output voltage transient is slower, with a settling time of approximately 27 μs, thus, implying an around two times faster transient response due to the air-coupled inductor. Additionally, similar to the simulation results, the voltage overshoot due to the duty ratio step change 250 is reduced when the air-coupled inductor is used as the input inductors of the converter.

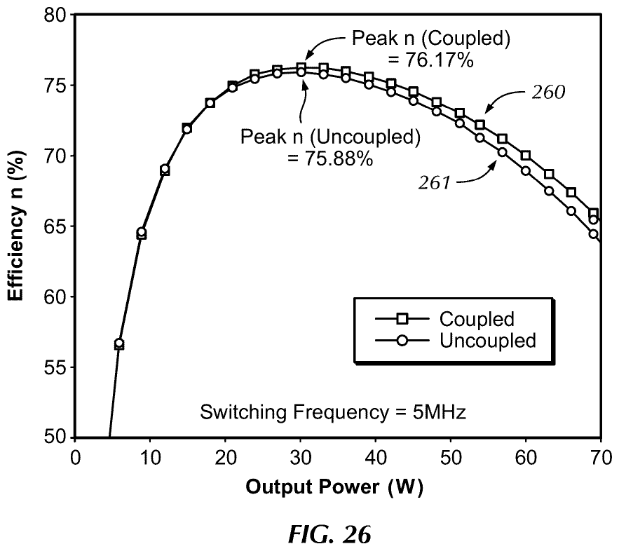

Referring now to FIG. 26, an experimental comparison of the converter efficiencies with an embodiment of the air-coupled inductors and uncoupled discrete inductors is shown. The efficiency of the four-phase interleaved boost converter was measured both with and without the air-coupled inductor. The converter efficiency was measured at a switching frequency of 5 MHz with interleaved gate signals. The converter was operated in a continuous conduction mode with a fixed input voltage of 5V. The output load was varied while keeping the output voltage constant at 12V. The input to output voltage conversion ratio is kept constant by constantly adjusting the duty ratio of the interleaved gate signals. The system efficiency for an embodiment of the disclosed air-coupled inductors 260 had a peak efficiency of 76.17%. The efficiency of the uncoupled discrete inductors 261 was measured at 75.88%. At higher output powers, the multiphase three-dimensional air-coupled inductors are even more efficient than the discrete inductors. This is because the phase current ripple is larger without the coupled inductor, which leads to more losses in comparison to the coupled system. As the output power increases, the difference in the input current also increases, and as a result, the difference in the coupled and uncoupled system efficiencies become even more pronounced.

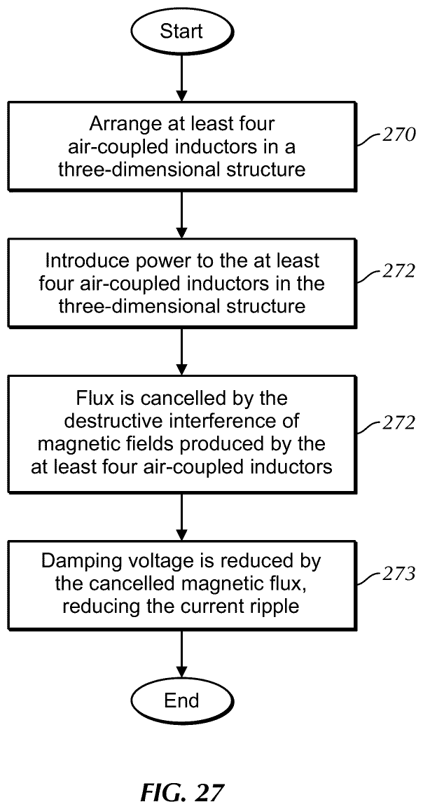

Referring to FIG. 27, a flow chart describing an implementation of three-dimensional air-coupled inductors is shown. Firstly, at least four air-coupled inductors must be arranged in a three-dimensional geometry 270. The three-dimensional structure could embody any three-dimensional geometry. Power must then be introduced to the at least four air-coupled inductors in the three-dimensional geometry 271. As a result of power being introduced, the three-dimensional air-coupled inductors will emit magnetic fields, which due to their geometry will cause flux cancelation 272. The flux cancellation will cause a reduction in the dampening voltages which ultimately reduces the current ripple 273.

Thus, in some aspects, a method for reducing phase current ripple may be provided. The method may include arranging at least four air-coupled windings in a three-dimensional structure in a manner such that a current would produce magnetic flux that points internal to the three-dimensional structure. The method may include introducing power to the at least four air-coupled windings in the three-dimensional structure. Introducing power may thereby create a flux cancellation through destructive interference of magnetic fields produced by the at least four air-coupled windings in the three-dimensional structure. Introducing power may reduce a dampening voltage produced by the magnetic flux of the at least four air-coupled windings. The method may include coupling a power source to the at least four air-coupled windings in the three-dimensional structure.

In some aspects, a method for improving transient response may be provided. The method may include arranging at least four air-coupled windings in a three-dimensional structure in a manner such that a current would produce magnetic flux that points internal to the structure. The method may include introducing power to the at least four air-coupled windings in the three-dimensional structure. Introducing power may thereby create a flux cancellation through destructive interference of magnetic fields produced by the at least four air-coupled windings in the three-dimensional structure. Introducing power may reduce a dampening voltage produced by the magnetic flux of the at least four air-coupled windings. This may cause a reduction in settling time of the at least four air-coupled windings. The method may include coupling a power source to the at least four air-coupled inductors in the three-dimensional structure.

While various embodiments have been described above, it should be understood that they have been presented by way of example only, and not limitation. Thus, the breadth and scope of a provided embodiment should not be limited by any of the above-described exemplary embodiments but should be defined only in accordance with the following claims and their equivalents.

What is claimed:

1. A three-dimensional multiphase air-coupled inductor device, comprising:
a plurality of air-coupled windings, a main magnetic path of each air-coupled winding operably coupled together in a three-dimensional volume of space; and
where outer surfaces of the plurality of air-coupled windings enclose a three-dimensional surface around the three-dimensional volume of space.

2. The three-dimensional multiphase air-coupled inductor device according to claim 1, wherein a coupling coefficient of each air-coupled winding joined to another air-coupled winding is uniform.

3. The three-dimensional multiphase air-coupled inductor device according to claim 2, wherein the three-dimensional surface forms a platonic structure.

4. The three-dimensional multiphase air-coupled inductor device according to claim 2, wherein the three-dimensional surface forms a non-platonic structure.

5. The three-dimensional multiphase air-coupled inductor device according to claim 2, wherein the outer surfaces consist of planar surfaces.

6. The three-dimensional multiphase air-coupled inductor device according to claim 2, wherein the outer surfaces comprise a non-planar surface.

7. The three-dimensional multiphase air-coupled inductor device according to claim 2, further comprising a magnetic shield configured to guide magnetic flux.

8. The three-dimensional multiphase air-coupled inductor device according to claim 2, further comprising a ferrite sheet configured to guide magnetic flux.

9. The three-dimensional multiphase air-coupled inductor device according to claim 2, wherein each air-coupled winding is wound in a same orientation.

10. The three-dimensional multiphase air-coupled inductor device according to claim 2, wherein at least one of the plurality of air-coupled windings is wound in a different orientation from at least one other air-coupled winding of the plurality of air-coupled windings.

11. A system, comprising:
a three-dimensional multiphase air-coupled inductor device according to claim 1; and
at least one circuit operably coupled to the three-dimensional multiphase air-coupled inductor device.

12. The system according to claim 11, wherein the at least one circuit comprises a conductive pattern on a printed circuit board.

13. The system according to claim 11, wherein the system forms an N-phase power converter, each phase controlled by an interleaved pulse-width modulated (PWM) signal.

14. A method of reducing phase current ripple, comprising:
arranging at least four air-coupled inductors in a three-dimensional structure in a manner such that a current would produce a magnetic flux that points internal to the three-dimensional structure; and
introducing power to the at least four air-coupled inductors in the three-dimensional structure thereby creating flux cancellation through destructive interference of magnetic fields produced by the at least four air-coupled inductors in the three-dimensional structure and reducing a dampening voltage produced by the magnetic flux of the at least four air-coupled inductors.

15. A method for improving transient response, comprising:
arranging at least four air-coupled inductors in a three-dimensional structure in a manner such that a current would produce a magnetic flux that points internal to the three-dimensional structure; and
introducing power to the at least four air-coupled inductors in the three-dimensional structure thereby creating flux cancellation through destructive interference of magnetic fields produced by the at least four air-coupled inductors in the three-dimensional structure and reducing a dampening voltage produced by the magnetic flux of the at least four air-coupled inductors causing a reduction in settling time of the at least four air-coupled inductors.

16. The method of claim 15, further comprising coupling a power source to the at least four air-coupled inductors in the three-dimensional structure.
